(19) United States
(12) Patent Application Publication
(10) Pub. No.: US 2013/0088429 A1
(43) Pub. Date: Apr. 11, 2013

(54) APPARATUS AND METHOD FOR RECOGNIZING USER INPUT

(71) Applicant: Hea-Jin YANG, Seoul (KR)

(72) Inventor: Hea-Jin YANG, Seoul (KR)

(73) Assignee: PANTECH CO., LTD., Seoul (KR)

(21) Appl. No.: 13/467,455

(22) Filed: May 9, 2012

(30) Foreign Application Priority Data
Oct. 5, 2011 (KR) 10-2011-0101128
Oct. 17, 2011 (KR) 10-2011-0106085

(51) Int. Cl. G06F 3/033

(52) U.S. Cl. 345/158

(57) ABSTRACT

An apparatus includes an image sensor to obtain optical image information, a control unit to generate input recognition information based on the optical image information, and to determine a user input based on the input recognition information, and a display unit to display control information corresponding to the user input. A method for recognizing a user input includes obtaining optical image information, generating input recognition information based on the optical image information, the input recognition information including a region corresponding to an input object, and determining a user input based on the input recognition information.

### CROSS-REFERENCE TO RELATED APPLICATIONS

This application claims priority from and the benefit under 35 U.S.C. §119(a) of Korean Patent Applications No. 10-2011-0101128, filed on Oct. 5, 2011, and No. 10-2011-0106085, filed on Oct. 17, 2011, both of which are hereby incorporated by reference for all purposes as if fully set forth herein.

### BACKGROUND

1. Field

The following description relates to an apparatus and method for recognizing a user input, and more particularly, to an apparatus and method for recognizing a user input using an input sensor.

2. Discussion of the Background

Various user interfaces have been developed to provide a method for manipulating a touch screen employed in a portable terminal, such as a mobile communication terminal, a handheld electronic tablet (an electronic pad), a computer, and the like, and recognizing a user's touch and gesture inputs through the touch screen.

Conventional methods of recognizing a touch input have evolved to provide and enhance a multi-touch input by increasing the number of simultaneous touches to be recognized, such as a one touch, a double touch and a multi touch (which may include a double touch). The conventional methods have also developed toward decreasing the resistance of a touch, from a resistive overlay method to a capacitive overlay method. In a conventional method of recognizing a gesture input, specific gesture information corresponding to specific touch input information may be previously set and stored, and an actual touch input may be recognized as the previously set information corresponding thereto. In the conventional methods, a user's touch operation may provide an input interface.

However, a touch input may not be available in an environment in which a user cannot use both hands or where one hand may be otherwise occupied, for example when driving, doing makeup, cooking or the like. A user may be reluctant to touch the touch screen if user's hands are unclean. Then, the user may want to touch the touch input device after washing his/her hands. Meanwhile, in the capacitive overlay method in which a touch input may be recognized according to a varying voltage or a capacitive value caused by a touch input of a user, a malfunction may occur due to moisture, or a touch input produced when a hand is covered by a glove made of an insulating material. Further, the surface of a touch window may be vulnerable to sudden changes in temperature. Thus, when a sudden change in temperature occurs, the malfunction may occur due to malfunction of touch sensors or an inhibition created on the surface of the touch screen, such as frost or condensation.

### SUMMARY

Exemplary embodiments of the present invention provide an apparatus and method for recognizing a user input using an input sensor, which may include an image sensor such as a camera. A user input image may be analyzed and processed.

Additional features of the invention will be set forth in the description which follows and, in part, will be apparent from the description, or may be learned by practice of the invention.

An exemplary embodiment of the present invention provide an apparatus, including an image sensor to obtain optical image information; a control unit to generate input recognition information based on the optical image information, and to determine a user input based on the input recognition information; and a display unit to display control information corresponding to the user input.

An exemplary embodiment of the present invention provide a method for recognizing a user input, including obtaining optical image information; generating input recognition information based on the optical image information, the input recognition information including a region corresponding to an input object; and determining a user input based on the input recognition information.

An exemplary embodiment of the present invention provide a method for recognizing an input, including receiving optical information including information of an input object; generating an input recognition frame based on the optical information, the input recognition frame including a region corresponding to the input object and boundaries of the region being determined based on the optical information; and determining the input according to a location change of the region based on multiple input recognition frames.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic block diagram illustrating an apparatus to recognize a user input using a camera according to an exemplary embodiment of the present invention.

FIG. 2 is a diagram illustrating a screen for setting an event to operate the camera in an operation recognition mode according to an exemplary embodiment of the present invention.

FIG. 3A, FIG. 3B, FIG. 3C, and FIG. 3D are diagrams illustrating analyzed image frames according to an exemplary embodiment of the present invention.

FIG. 4 is a flowchart illustrating a method for recognizing a user input using a camera according to an exemplary embodiment of the present invention.

FIG. 5 is a diagram illustrating a method for recognizing a user input if a call or short message service (SMS) message is received according to an exemplary embodiment of the present invention.

FIG. 6 is a diagram illustrating a method for recognizing a user input for an operation for selecting a previous/next song in a music player according to an exemplary embodiment of the present invention.

FIG. 7 is a diagram illustrating a method for recognizing a user input for an operation for selecting volume up/down in the music player according to an exemplary embodiment of the present invention.

FIG. 8 is a diagram illustrating a method for recognizing a user input for an operation for selecting left/right scrolling of a gallery thumbnail according to an exemplary embodiment of the present invention.

FIG. 9 is a diagram illustrating a method for recognizing a user input for an operation for selecting a next/previous view of individual photographs or moving images in a gallery according to an exemplary embodiment of the present invention.

FIG. 10 is a diagram illustrating a method for recognizing a user input for an operation for selecting a next/previous page view in an e-book according to an exemplary embodiment of the present invention.

FIG. 11 is a diagram illustrating an input recognition frame according to an exemplary embodiment of the present invention.

FIG. 12 is a diagram illustrating an input recognition frame according to an exemplary embodiment of the present invention.

FIGS. 13A and 13B are diagrams illustrating a method for operating an operation recognition mode according to an exemplary embodiment of the present invention.

FIG. 14 is a diagram illustrating examples of analyzed types of input objects according to an exemplary embodiment of the present invention.

FIGS. 15A and 15B are diagrams illustrating a method for recognizing a user input using a mobile terminal having one or more cameras according to an exemplary embodiment of the present invention.

FIG. 16 is a diagram illustrating a method for recognizing a user input using a camera according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

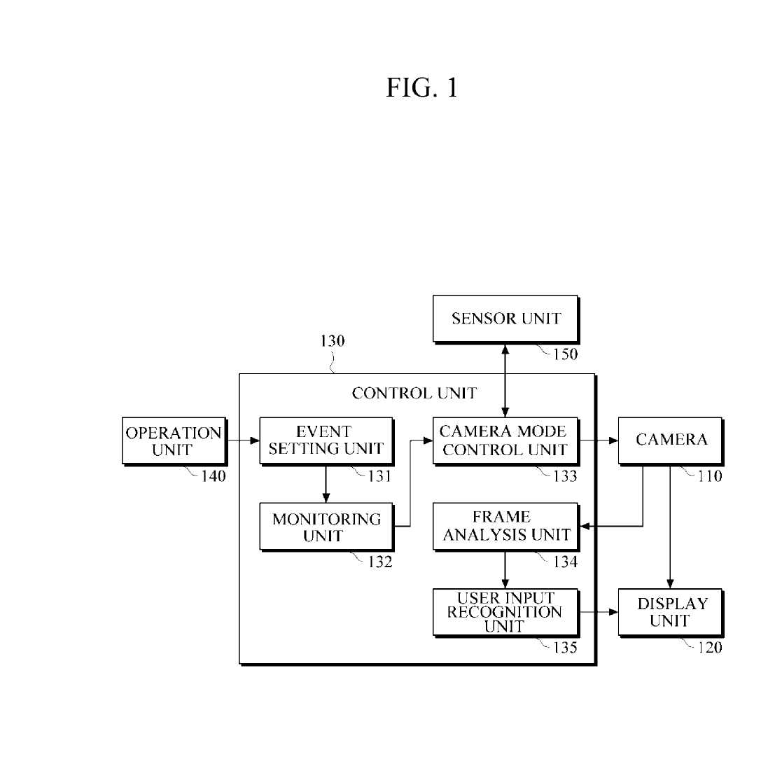

FIG. 1 is a schematic block diagram illustrating an apparatus to recognize a user input using a camera according to an exemplary embodiment of the present invention.

The apparatus may be applied not only to a mobile communication terminal, such as a cellular phone, a smart phone, a personal digital assistant (PDA), or a navigation terminal, but also to a personal computer, such as a desktop computer or a laptop computer. Further, the apparatus may be applied to various devices capable of recognizing a user's operation image as user input information.

Referring to FIG. 1, the apparatus includes a camera 110, a display unit 120, and a control unit 130. The apparatus may include an operation unit 140 and a sensor unit 150.

The camera 110 may capture a sequence of images and output the images in the form of frames. The images may be still or moving images. The camera 110 may include an image processing module capable of magnifying or reducing an image under the control of the control unit 130, or manually or automatically rotating the image if the image is captured by the camera. The camera 110 may be operated in one of a plurality of modes including a photographing mode and an operation recognition mode. The photographing mode refers to an operation mode in which frames of captured images are displayed in the display unit 120. In the photographing mode, captured images may be captured, stored, and displayed on the display unit 120 in real-time. The operation recognition mode refers to a mode in which one or more image objects are captured and an input operation is recognized based on the captured image objects. The operation recognition mode may be referred to as an input recognition mode. In the operation recognition mode, image frames including the image objects may not be displayed on the display unit 120 but transmitted to the control unit 130 and be analyzed to generate user input information. In the operation recognition mode, the camera 110 may be operated as a user input interface. Further, the camera 110 may be operated in one mode among various mode including the photographing mode and the operation recognition mode under the control of the control unit 130. Further, the camera 110 may be simultaneously operated in a plurality of modes, the operation recognition mode and the photographing mode, for example, when photographing oneself.

The display unit 120 may include a display panel for outputting an image. The display unit 120 may display an image captured by the camera 110 and stored, or an input interface image generated based on the captured image. The display panel may include a liquid crystal display (LCD) panel, a light-emitting diode (LED) panel, an organic light-emitting diode (OLED) panel, a flexible display panel, a touch screen display panel, a transparent display panel, or the like. The display unit 120 may be included in the apparatus or may be separately connected to the apparatus via an interface such as a wired connector including a USB connector, a short range wireless communication interface including Bluetooth, and the like. The display unit 120 may display and output information, data, or image processed in the apparatus, and display a user interface (UI) or a graphic user interface (GUI) related to a control operation. Further, a setting screen may be displayed by the display unit 120 and may be used for setting an event to operate the camera 110 in the operation recognition mode. If a sensor to sense a touch input (hereinafter referred to as a ‘touch sensor’) has an interlayer structure in the display unit 120, the display unit 120 may be used as a manipulation unit by receiving a user input.

The operation unit 140 may receive an input from a user, and may include, for example, a key input unit for receiving a key input if a key is pressed, a touch sensor, a mouse, etc. The operation unit 140 may receive event setting information to use the camera as an input device, which is input from the user. The operation unit 140 may provide a user interface while the camera 110 is not in operation recognition mode.

The sensor unit 150 may include a proximity sensor, an ultrasound sensor, etc., and may include a sensor capable of sensing an access of an object. For example, an Infrared light-emitting diode (IR LED) may be used as the proximity sensor. Further, in response to the access recognized by the sensor unit 150, the sensor unit 150 may generate access sensing information and the access sensing information may be used as control information for turning on/off the camera 110 or for control information for initiating or terminating the operation recognition mode. If the camera 110 is continuously operated in the operation recognition mode, battery consumption rate may be accelerated. Thus, the camera 110 may not be operated if the camera 110 is not in the operation recognition mode or the photographing mode. Thus, a sensor causing relatively lower battery consumption may be used as the sensor unit 150 for turning on/off the camera 110. For example, if the camera 110 is in the operation recognition mode while a music player is operated, battery consumption rate may be accelerated. Thus, the camera 110 may be turned off and the sensor unit 150 may be operated during the playback of a multimedia player without a user input. Further, a key input may be used for initiating or terminating the operation recognition mode.

The control unit 130 may control the camera 110, the display unit 120, the operation unit 140, and the sensor unit 150, and may include one or more processors to execute instructions and a software module executed in the one or more processor. The control unit 130 may include an event setting unit 131, a monitoring unit 132, a camera mode control unit 133, a frame analysis unit 134, and a user input recognition unit 135.

The event setting unit 131 may provide a setting interface to set one or more events to cause the camera 110 to be operated in the operation recognition mode. The event setting unit 131 may display a setting screen for setting one or more events to initiate or terminate the operation recognition mode. The setting screen may be displayed in the display unit 120 according to a user input via the operation unit 140.

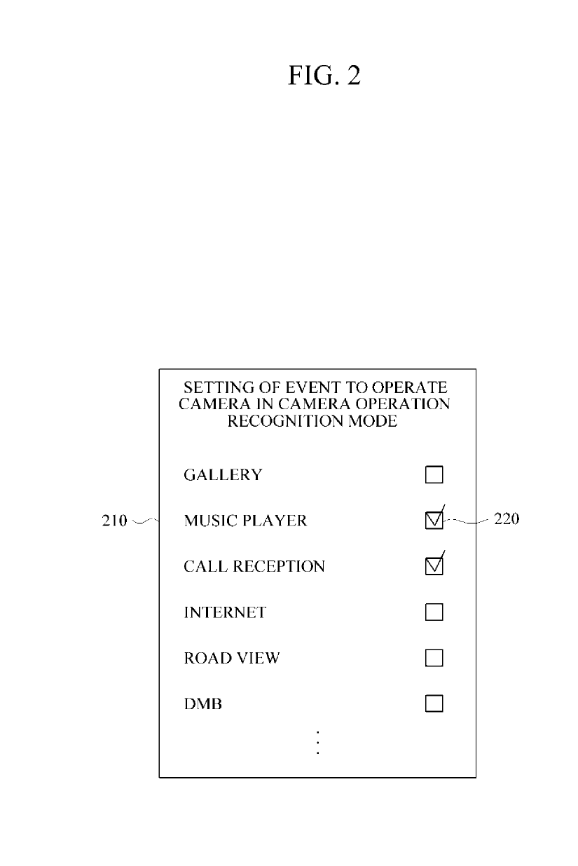

FIG. 2 is a diagram illustrating a screen for setting an event to operate the camera in an operation recognition mode according to an exemplary embodiment of the present invention.

Referring to FIG. 2, an event list 210 and corresponding check boxes 220 may be included in a setting screen. The event list 210 may include applications, situations used in the apparatus, and the check boxes 220 indicate whether the corresponding event causes the camera 110 to be operated in the operation recognition mode when the event occurs. The event setting unit 131 may store events selected by the user to provide the operation recognition mode. For example, as shown in FIG. 2, ‘music player’ and ‘call reception’ may be selected and stored as the events for providing operation recognition mode.

The monitoring unit 132 may monitor whether an event set by the event setting unit 131 occurs. If the event occurs, the monitoring unit 132 may determine the occurrence of the event and transmit a control signal to the camera mode control unit 133.

In response to the control signal from the monitoring unit 132, the camera mode control unit 133 may initiate the operation recognition mode and operate the camera 110 in the operation recognition mode. In the operation recognition mode, the camera 110 may not output captured images via the display unit 120 and may instead output the captured images to the frame analysis unit 134. If the camera 110 is in operation in the operation recognition mode while the display unit 120 is turned off or an application is operated in the background, unnecessary battery consumption may occur. Thus, the camera mode control unit 133 controls the camera 110 to be turned off if the display unit 120 is turned off or applications are running in the background. If the event for recognizing the operation of the camera 110 is not terminated, the camera 110 may be temporarily turned off until the sensor unit 150 senses an access of an object. Hence, the camera mode control unit 133 may control the sensor unit 150 as described above, and control the camera 110 to be turned on according to the access sensing information transmitted from the sensor unit 150. If the camera mode control unit 133 receives the access sensing information in the state in which the camera 110 is turned off, the camera mode control unit 133 may control the camera 110 to be operated in the operation recognition mode.

The frame analysis unit 134 may analyze image frames of captured images input from the camera 110 in the operation recognition mode. The image frames may be generated at about 20 to about 28 frames per second, but are not limited as such. In this case, the number of the image frames may be adjusted to control an operational recognition rate.

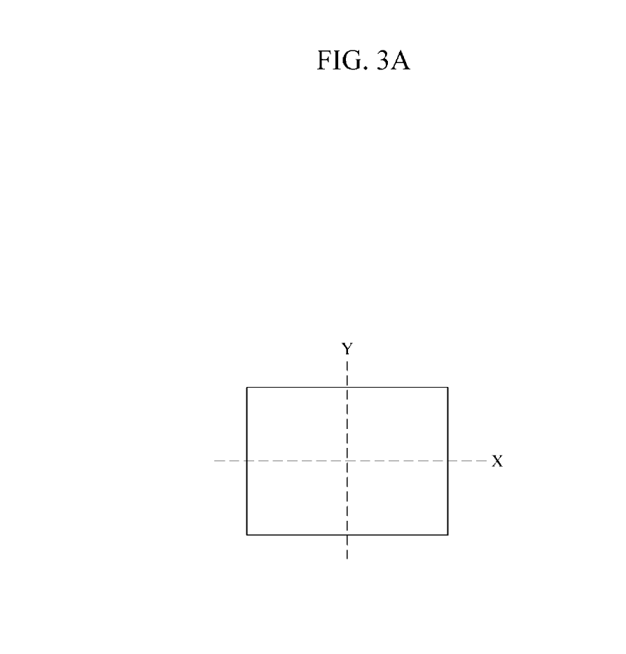

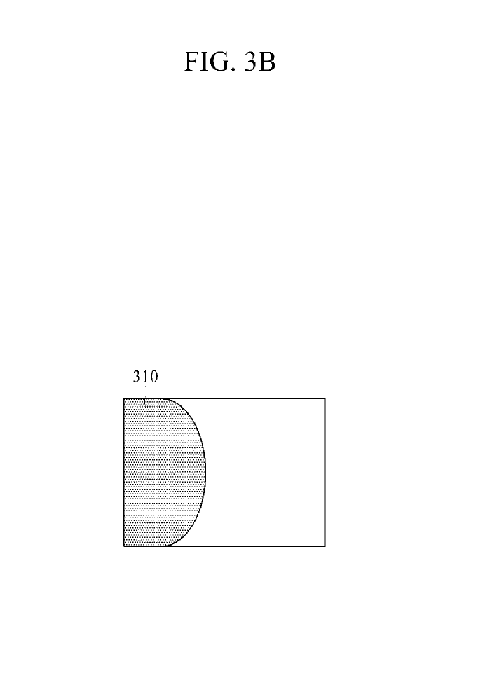

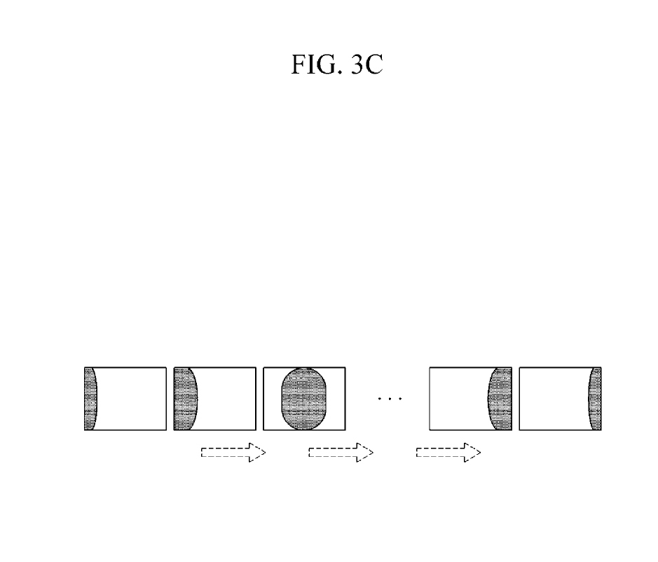

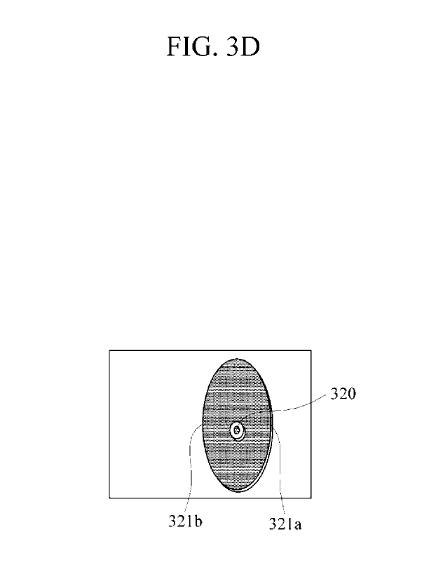

FIG. 3A, FIG. 3B, FIG. 3C, and FIG. 3D are diagrams illustrating analyzed image frames of captured images according to an exemplary embodiment of the present invention. FIG. 3B, FIG. 3C, and FIG. 3D may be referred to as an input recognition frame.

Referring to FIG. 3A, in an image frame of the captured images, X- and Y-axes may be formed based on a viewing angle and/or an orientation of the camera 110. For example, the apparatus may provide a portrait mode and a landscape mode. The landscape mode refers to a horizontal orientation of an apparatus where the horizontal axis is longer than the vertical axis as shown in FIG. 3A, and the portrait mode refers to a vertical orientation of the apparatus where the horizontal axis is shorter than the vertical axis. As shown in FIG. 3A, X- and Y-axes may be formed along the horizontal axis and the vertical axis, respectively. Thus, reference axes with respect to a moving object may also be formed differently according to the orientation of the apparatus. An image frame corresponding to a surrounding image captured by the camera 110 may be used as the input recognition frame. However, more simplified data may be used for the input recognition frame as described below.

Meanwhile, if the captured image including a large amount of information is used without simplification, the quantity of data to be analyzed increases. Thus, more time and CPU resources may be used to analyze the data. To address this problem, the frame analysis unit 134 may extract a shadow region according to the brightness of each pixel in an image frame of a captured image. The shadow region may be determined as a user's hand or specific input object captured by the camera 110. Referring to FIG. 3B, the shadow region 310 may be distinguished from a bright region according to the brightness of each pixel in the frame of the captured image. For example, pixels having brightness values less than a threshold brightness value may be separated as the shadow region 310. However, the pixels of the entire image may have brightness values less than the threshold brightness value due to a scarcity of light (i.e., night or a shadow). In order to reduce risks of an error occurring due to the scarcity of light, the frame analysis unit 134 may calculate an average brightness value of the entire image and extract pixels having brightness values less than the calculated average brightness value by an offset value as the shadow region 310, for example. Further, the threshold brightness value may be adjusted based on the average brightness value.

Since the position of the input object, such as the user's hand, in the captured image may be changed frame by frame according to the movement of the input object, the frame analysis unit 134 may analyze a change of data in the captured images between frames (“image frames”), for example between adjacent frames. Referring to FIG. 3C, the position of the shadow region extracted according to the brightness of the captured image may be changed as the input object moves. Thus, the frame analysis unit 134 may calculate start and end points in the movement of the input object by comparing the coordinates of the previous frame with the coordinates of the next frame. The frame analysis unit 134 may not obtain the coordinates of the entire dark part of the shadow region but may obtain a feature point, such as a centroid, or boundary feature points, such as a plurality of points corresponding to the boundary of the shadow region, in the shadow region and recognize the movement according to the change in the coordinates of the feature point or the boundary feature points.

Referring to FIG. 3D, the feature point may be a central point of the area of the shadow region, and the central point may be calculated based on the boundary of the shadow region, for example. Further, values for the X- and Y-axes may be calculated by calculating a moving distance of the shadow region with respect to the area of the entire captured image. The feature point may be a centroid 320 of the shadow region or a central point of left/right boundary lines 321a and 321b. The central point may be mapped to a pointer that may be displayed on the display unit 120. Thus, the user may recognize the mapped location of the input object on the display unit 120 by tracking the movement of the displayed pointer.

If the camera 110 is connected to different kinds of devices, the coordinates of the feature point may be changed. Further, virtual X and Y active regions (a virtual X-Y plane mapped to a touch screen to display image frames) may not be fixed as the size of a touch screen. For example, the size of the virtual X-Y plane projected by the camera 110 to receive an input image including the input object may vary based on one or more parameters, such as the distance between the camera 110 and the input object, the viewing angle of the camera 110, and the like. The frame analysis unit 134 may not extract a coordinate value of the feature point represented by a coordinate value (X, Y) but may extract a vector value representing a velocity of the feature point, for example, V=(Vx, Vy) or V=(Vx, Vy, Vz) where V denotes a vector representing the velocity of a feature point, and Vx, Vy, and Vz denote a moving speed of the feature point along the X-axis, the Y-axis, and the Z-axis perpendicular the X-Y plane, respectively. The Vx and Vy may be calculated based on the moving distance of the feature point in the X-Y plane as shown in FIG. 3A per each frame. The Vz may be calculated based on the size change of the input object per each frame. For example, if the area surrounded by the boundary of the input object increases, Vz may have a positive value. Further, the frame analysis unit 134 may determine the movement direction of the input object using a vector value obtained by connecting changes in a plurality of feature points. Since the number of image frames captured per unit time may be constant, the velocity may be calculated according to the length of the vector generated in the frames captured per unit time.

If an up/down (up or down) operation or left/right (left or right) operation is performed, the frame analysis unit 134 may extract a vector value or coordinate value of the operation by comparing values of consecutive frames as described above. The up operation refers to a recognized movement of the input object with an increment of the Y coordinate value. The down operation refers to a recognized movement of the input object with a decrement of the Y coordinate value. The right operation refers to a recognized movement of the input object with an increment of the X coordinate value. The left operation refers to a recognized movement of the input object with a decrement of the X coordinate value. If the X coordinate value or the Y coordinate value increases and then decreases (decreases and then increases) during a certain period of time (e.g., ‘n’ sec.), the operation may be recognized as a shaking operation. If there is no change in brightness per frame for predetermined certain period of time (e.g., ‘n’ sec.), the operation may be recognized as a covering operation.

Referring back to FIG. 1, the user input recognition unit 135 may determine the type of a user input based on the value calculated by the frame analysis unit 134. Table 1 illustrates an example of analysis results mapped to movements.

TABLE 1

| Movement (Frame analysis unit's | |
|---|---|
| determination) | Analysis result |
| Movement of hand from left to right | Occurrence of event in |
| | direction of “→” under |
| | interface control |
| Movement of hand from right to left | Occurrence of event in |
| | direction of “←” under |
| | interface control |
| Movement of hand from bottom to top | Occurrence of event in |
| | direction of “↑” under |
| | interface control |
| Movement of hand from top to bottom | Occurrence of event in |
| | direction of “↓” under |
| | interface control |
| Shaking of hand along the horizontal axis | Conversion of specific |
| (left/right) during a reference time | event under interface |
| | control |
| Covering a portion of the camera sensing area | Occurrence of “stop” or |
| (e.g., covering the portion of the camera | “finish” event of event |
| sensing area by hand) for a reference time | progressing under |
| | interface control |

Although not illustrated in FIG. 1, the apparatus may further include a communication unit (not shown). If the apparatus recognizes a user input by recognizing a movement of the shadow region with respect to contents or applications including gallery photographs, moving images, e-books, etc., the control unit 130 may upload the contents to a server linked with the apparatus through the communication unit.

If a touch input on the touch screen is input by the user in the operation recognition mode, the control unit 130 may automatically terminate the operation recognition mode.

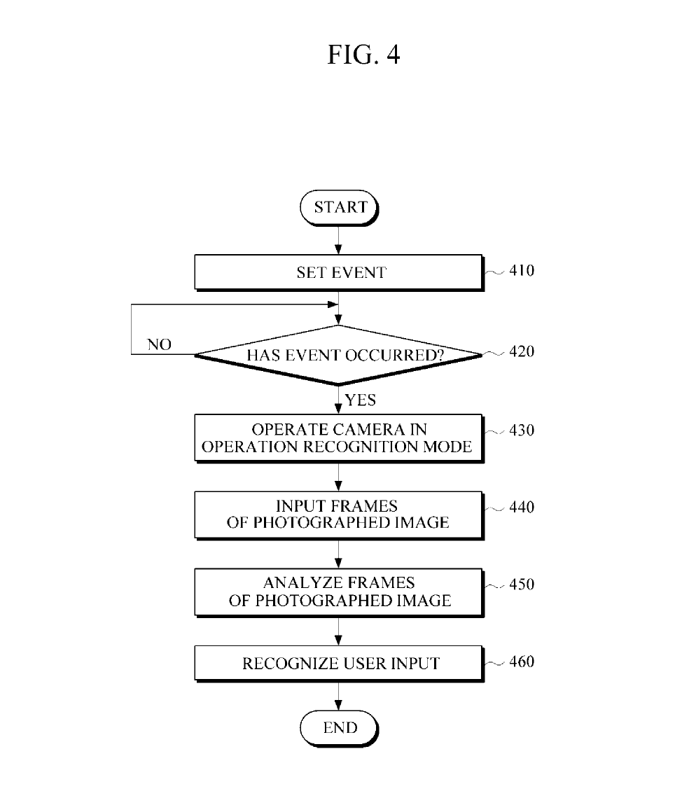

FIG. 4 is a flowchart illustrating a method for recognizing a user input using a camera according to an exemplary embodiment of the present invention. FIG. 4 will be described as if performed by apparatus shown in FIG. 1, but is not limited as such.

In step 410, the control unit 130 may set an event to operate the camera 110 in an operation recognition mode in which a captured image may be used as a user input. In the setting of the event, one or more events may be selected via a setting screen including the event list 210 and the check boxes 220 as illustrated in FIG. 2. The selected events may be determined as events for initiating or terminating the operation recognition mode.

In step 420, the control unit 130 may monitor whether the events set for the operation recognition mode occur.

If the events set for the operation recognition mode occur, the control unit 130 may control the camera 110 to operate in the operation recognition mode in step 430. Further, the control unit 130 may control the camera 110 to be turned off if the display unit 120 is turned off so as to prevent unnecessary battery consumption of the camera 110 or if an application for one of the set events is operated in the background. If the set event is, for example, call reception, the control unit 130 may control the camera 110 to be turned off and terminate the operation recognition mode after the call reception is completed.

If two or more consecutive frames of the captured images (e.g., photographed image) are input from the camera 110 in step 440, the control unit 130 may extract a shadow region by analyzing the two or more frames of the captured images (e.g., photographed image) and obtain change information of the shadow region by comparing the frames of the captured images (e.g., photographed image) in step 450. Specifically, the control unit 130 may extract pixels having brightness values less than the threshold brightness value in each of the frames as the shadow region. Further, the control unit 130 may calculate an average brightness value of the pixels in the image captured by the camera 110, and obtain the change information of the shadow region using the pixels having brightness values less than the calculated average brightness value by an offset value. Further, the threshold brightness value may be adjusted based on the average brightness value. For example, if the average brightness value decreases, the threshold brightness value may also decrease. Further, if the average brightness value is lower than the brightness of the input object, the control unit 130 may extract pixels having brightness values larger than the threshold brightness value in each of the frames as the shadow region. Further, the average brightness value for commonly used input object may be stored in the apparatus and be used to determine the threshold brightness value. Further, the control unit 130 may calculate start and end points of the user input according to the change in the coordinates of a feature point in the shadow region of the two or more frames. For example, the feature point may be one or more distinct points of the shadow region, the centroid of the shadow region, and/or the central point of left and right contours or boundaries. A vector having a direction and a speed depending on the change in the feature point may be extracted, and the velocity of the movement of the shadow region may be calculated based on values of the vector calculated for the frames captured per unit time. In the step 450, the control unit 130 may recognize the user input corresponding to the information on the movements of the shadow region.

Hereinafter, various examples for recognizing a user input using a camera will be described.

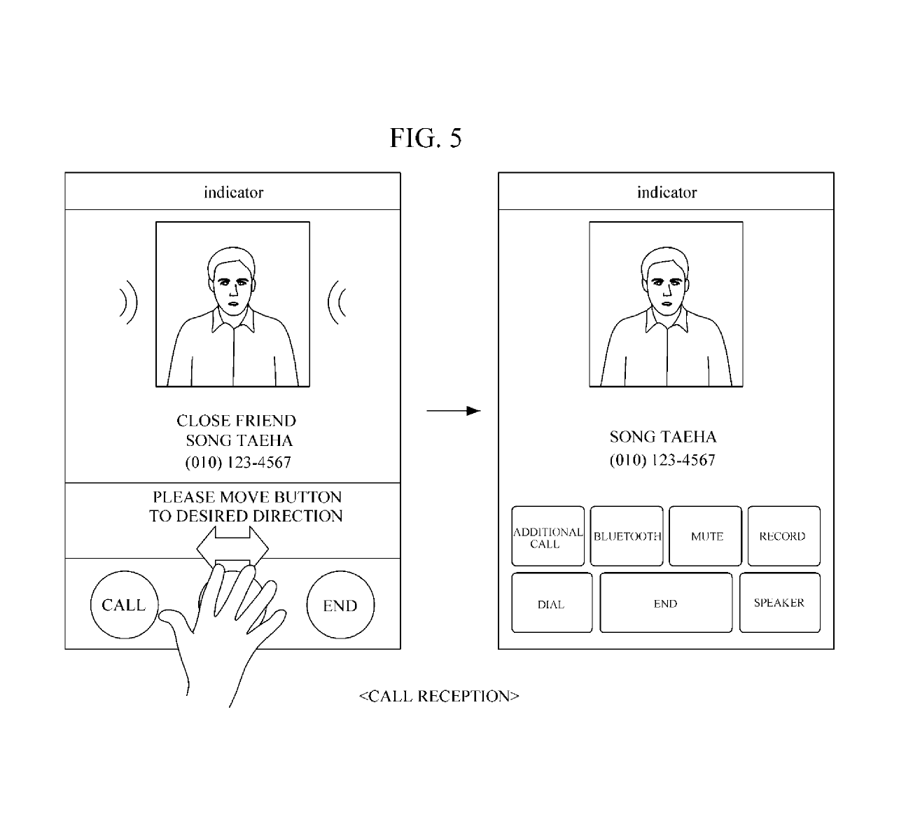

FIG. 5 is a diagram illustrating a method for recognizing a user input if a call or short message service (SMS) message is received according to an exemplary embodiment of the present invention. FIG. 5 will be described as if performed by apparatus shown in FIG. 1, but is not limited as such.

A user may not available to divert his or her attention to an apparatus such as a mobile terminal or to touch the apparatus with his or her hands since the hands are unavailable to perform precise inputs or dirty due to an activity, such as driving or cooking. Due to various reasons, for example, a user of a mobile terminal may want to receive a call by a gesture without touching the apparatus (e.g., shaking his or her hand). In response to a call reception waiting mode in which a mobile terminal outputs a call receiving signal indicating a call is being received (e.g., ringing, vibration, image, and the like), the camera 110 of the apparatus may initiate the operation recognition mode and recognize the movement of the user's gesture using the camera 110. If the camera 110 recognizes a gesture corresponding to a user input for receiving a call, the apparatus may transit the call reception waiting mode into a communication mode in which the user may communicate with the caller via the mobile terminal.

Further, the mobile terminal may convert the call reception waiting mode into the communication mode or display a received SMS message by recognizing various forms of user inputs. If a call is received during the operation recognition mode and it is determined that the user is not available to manipulate the mobile terminal, the call reception mode may be automatically changed into the communication mode without an additional input and the user may communicate with the caller. The automatic transition into the communication mode may be preset according to the user's selection. Further, if a SMS message is received, the operation recognition mode may be initiated. If the camera 110 detects a user input during the operation recognition mode, the content of the SMS message may be output in the form of a voice. Thus, the user may listen to the content of the SMS message without touching or looking at the mobile terminal.

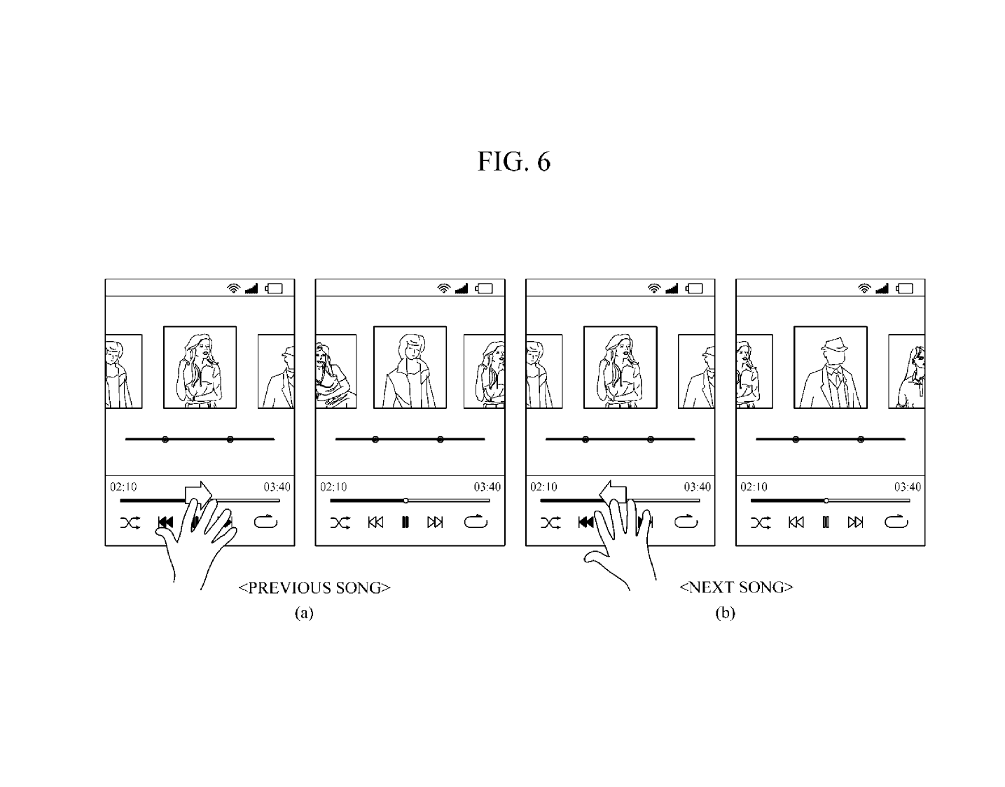

FIG. 6 is a diagram illustrating a method for recognizing a user input for an operation for selecting a previous/next song in a music player according to an exemplary embodiment of the present invention.

Referring to FIG. 6, the next song may be selected and played as a user's hand moves to the right as illustrated in (a), and the previous song may be selected and played as the user's hand moves to the left as illustrated in (b). The selected song may be controlled corresponding to the speed of the moving operation. For example, if a slow operation is recognized, the next song may be selected. If a fast operation is recognized, a number of songs (e.g., five songs) may be skipped. The slow operation may be a recognized movement of the input object of which moving speed is slower than a threshold speed value, and the fast operation may be a recognized movement of the input object of which moving speed is faster than a threshold speed value. However, it is not limited as such. The change rate of the output may be determined in proportional to the movement speed of the input object.

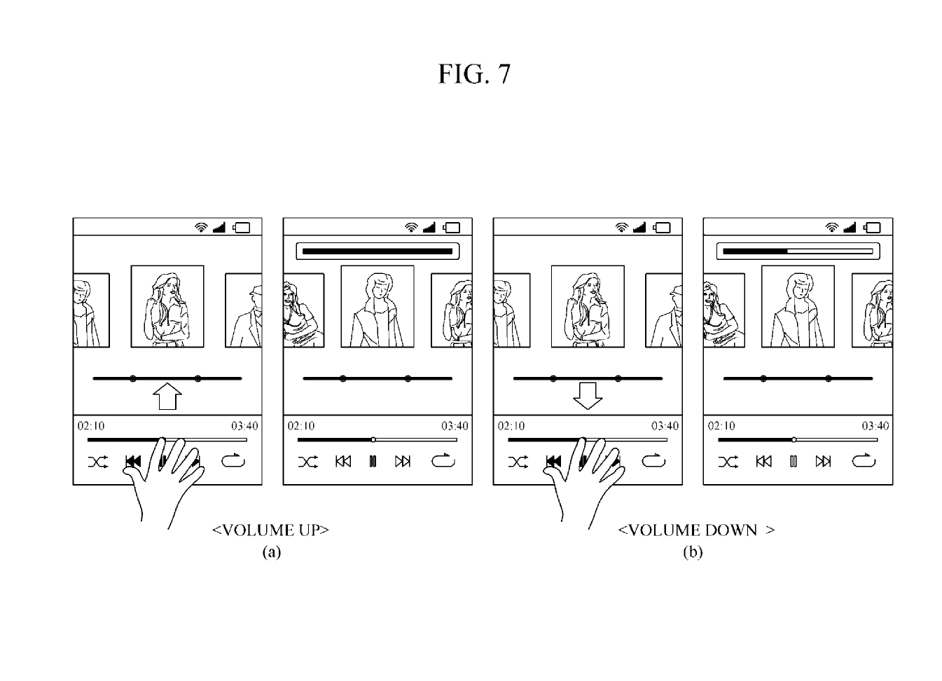

FIG. 7 is a diagram illustrating a method for recognizing a user input for an operation for selecting volume up/down in the music player according to an exemplary embodiment of the present invention.

Referring to FIG. 7, the volume may be increased as the user's hand moves up as illustrated in (a), and the volume may be decreased as the user's hand moves down as illustrated in (b). The volume changing rate may be controlled corresponding to the speed of the moving operation. For example, if a slow operation is recognized, the volume may be controlled relatively slowly. If a fast operation is recognized, the volume may be controlled more rapidly.

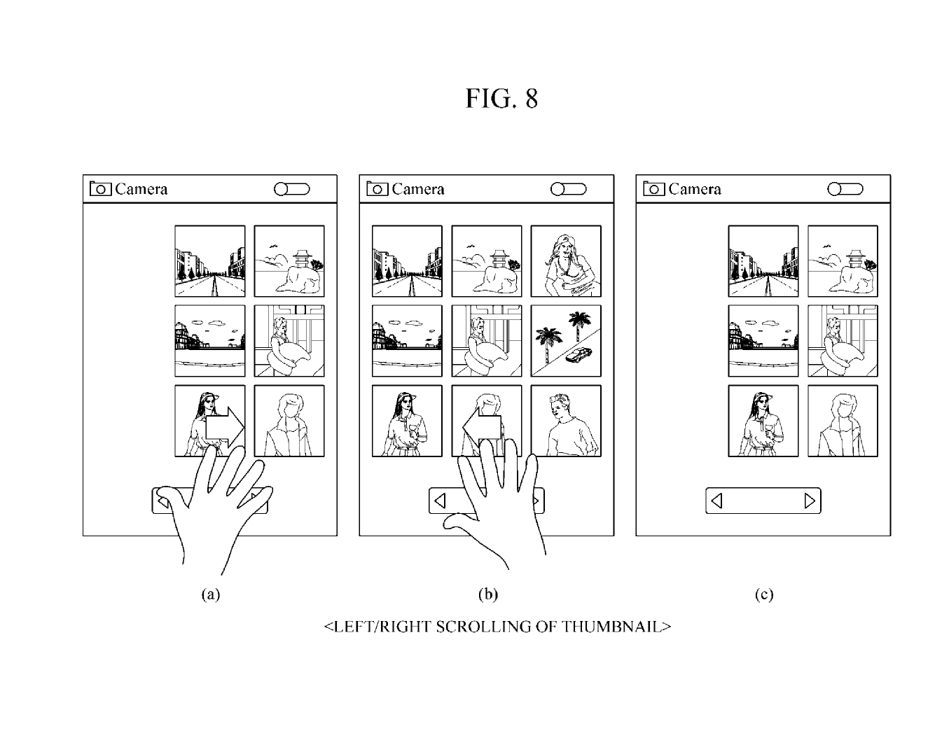

FIG. 8 is a diagram illustrating a method for recognizing a user input for an operation for selecting left/right scrolling of a gallery thumbnail according to an exemplary embodiment of the present invention.

Referring to FIG. 8, thumbnail of photographs or moving images may be moved to the right as the user's hand moves to the right as illustrated in (a), and the thumbnail of photographs or moving images may be moved to the left as the user's hand moves to the left as illustrated in (b).

The scroll speed of the photographs or moving images may be controlled corresponding to the speed of the moving operation. For example, if a slow operation is recognized, the photographs or moving images may be moved relatively slowly. If a fast operation is recognized, the photographs or moving images may be moved more rapidly.

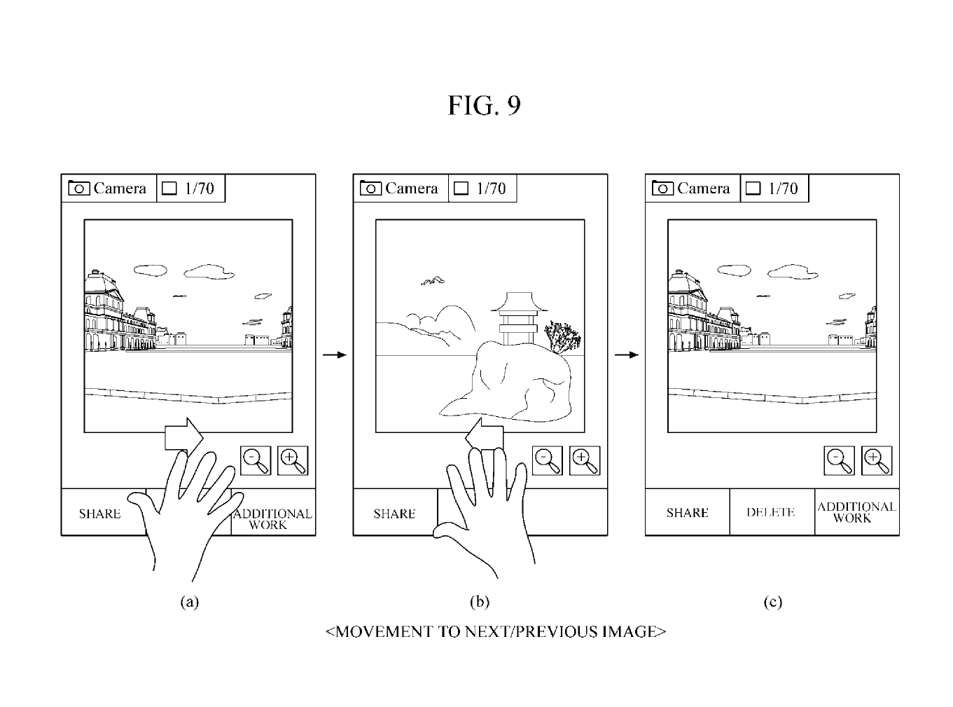

FIG. 9 is a diagram illustrating a method for recognizing a user input for an operation for selecting a next/previous view of individual photographs or moving images in a gallery according to an exemplary embodiment of the present invention.

Referring to FIG. 9, as the user's hand moves to the right as illustrated in (a), a previous photograph or moving image may be output as illustrated in (b). As the user's hand moves to the left as illustrated in (b), a next photograph or moving image may be output as illustrated in (c). The scroll speed of the photographs or moving images may be controlled corresponding to the speed of the moving operation. For example, if a slow operation is recognized, the photographs or moving images may be moved relatively slowly. If a fast operation is recognized, the photographs or moving images may be moved more rapidly.

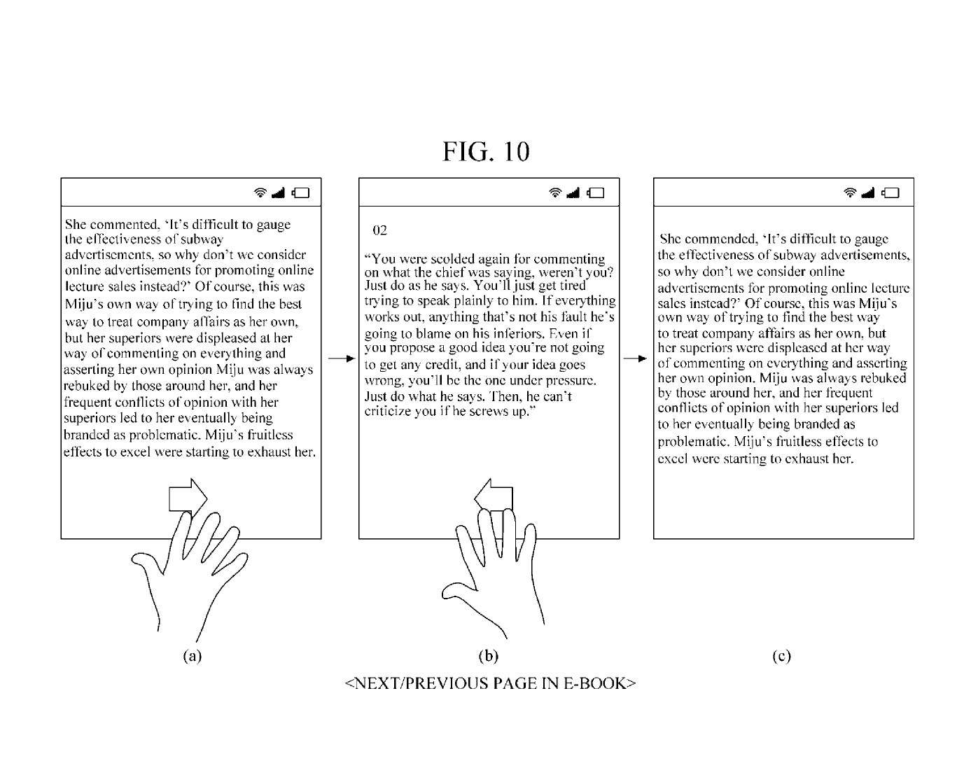

FIG. 10 is a diagram illustrating a method for recognizing a user input for an operation for selecting a next/previous page view in an e-book according to an exemplary embodiment of the present invention.

Referring to FIG. 10, if the user continuously touches a window using his or her hand when reading the e-book, a screen may become dirty due to fingerprints, dirt, and the like. To address this problem, the operation recognition mode may be used to turn a page without touching the window. As the user's hand moves from the right to the left, the user may turn the current page to the next page. As the user's hand moves from the left to the right, the user may turn the current page to the previous page. The speed of turning pages may be controlled corresponding to the speed of the moving operation. For example, if a slow operation is recognized, one page may be turned. If a fast operation is recognized, several pages may be turned at the same time.

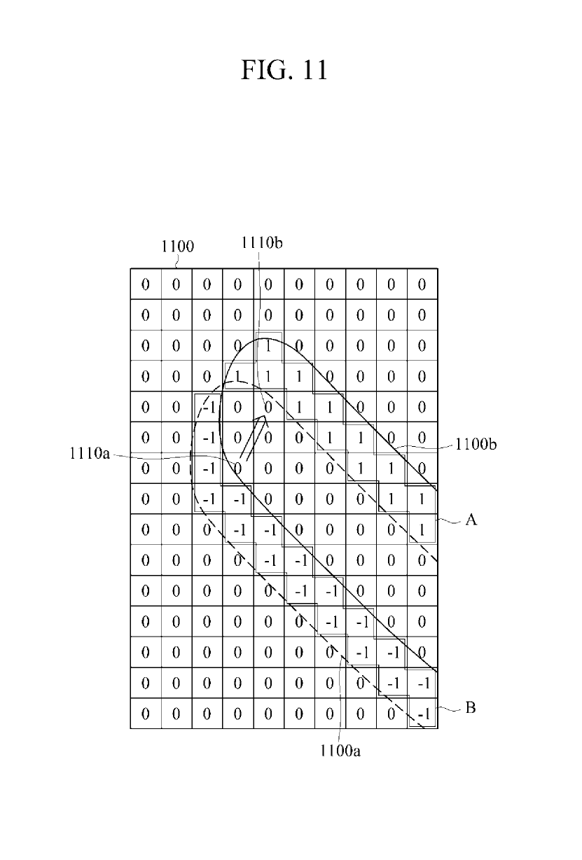

FIG. 11 is a diagram illustrating an input recognition frame according to an exemplary embodiment of the present invention. An image sensing device may be a charge-coupled device (CCD), a complementary metal-oxide-semiconductor (CMOS) sensor, and the like. A plurality of pixel units in the image sensing device may include photo sensors and the photo sensors may convert light energy into electric signals. The camera 110 shown in FIG. 1 may be the image sensing device and generate an input recognition frame 1100 based on a plurality of image frames. For example, the input recognition frame 1100 may be generated by comparing values obtained by pixel units and obtaining value changes in the pixel units during a unit time. A pixel unit may include one or more pixels. An input object may move to a different position during the unit time.

As shown in FIG. 11, a position 1100a of the input object may be changed to a position 1100b during a unit time. The image sensing device may capture images and generate input recognition frames 1100 periodically. The positions 1100a and 1100b of the input object may be relative positions mapped to a display screen. If the value change of a pixel unit is less than a reference value, a first value, such as ‘0’, indicating that the pixel does not correspond to the boundary of the input object may be determined for the input recognition value for the pixel unit. If the value change of a pixel unit is larger than or equal to a reference value, a second value, such as ‘1’, indicating that the pixel corresponds to the boundary of the input object may be determined for the input recognition value for the pixel unit. Further, the input recognition value for the pixel corresponding to the boundary of the input object may be distinguished into different values according to the moving direction. As shown in FIG. 11, the area A corresponding to the pixel units representing an advancing direction of the input object may have the value ‘1’ and the area B corresponding to the pixel units representing a receding direction of the input object may have the value ‘−1’, for example.

The boundary information of the input object and the moving direction of the input object may be analyzed based on information of the area A and area B. Further, a location, a moving direction, and a moving distance of a feature point may be calculated based on the information of the area A and area B. For example, the feature point in a first frame may be determined as a pixel unit 1110a and the feature point in a second frame may be determined as a pixel unit 1110b based on the information of the area A and area B. Further, a pointer may be displayed on the display screen such that the user may recognize the movement of the pointer on the display screen from an area corresponding to the pixel unit 1110a to an area corresponding to the pixel unit 1110b. Further, the frame analysis unit 134 may determine the feature point based on the shape of the input object. Since the area A and the area B indicate the shape of the input object is a bar-type or a finger-shaped type, the feature point may be determined based on the determined type of the input object. If an input object is an oval type as shown in FIG. 3D, the center of the input object may be determined as the feature point. Meanwhile, as described above with respect to FIG. 3A, FIG. 3B, FIG. 3C, and FIG. 3D, image frames captured by a camera may be used to determine a shadow region corresponding to an input object and to recognize a user input.

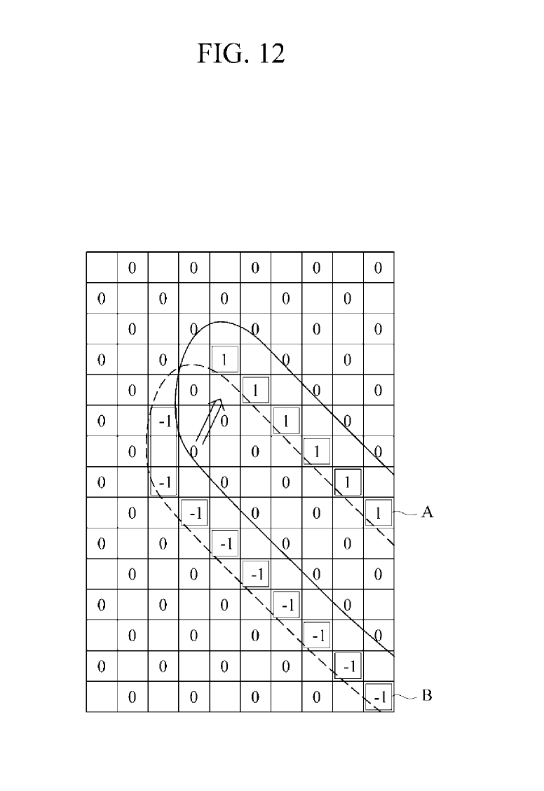

FIG. 12 is a diagram illustrating an input recognition frame according to an exemplary embodiment of the present invention. As shown in FIG. 12, the input recognition values may not be calculated for all pixel units to increase data processing rate. For example, one pixel unit between two adjacent pixel units may be selected as shown in FIG. 12. Further, although not illustrated, pixel units around the boundary areas A and B of the previous input recognition frame may be selected to obtain input recognition values. The input recognition frame may be generated periodically based on the unit time. Thus, the boundaries of the input object may be extracted in each input recognition frame without calculating input recognition values for all pixel units.

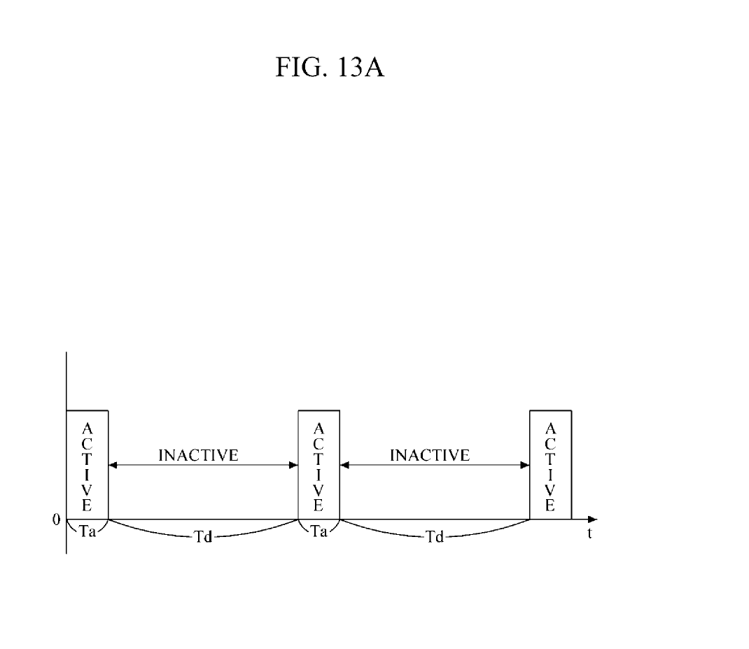

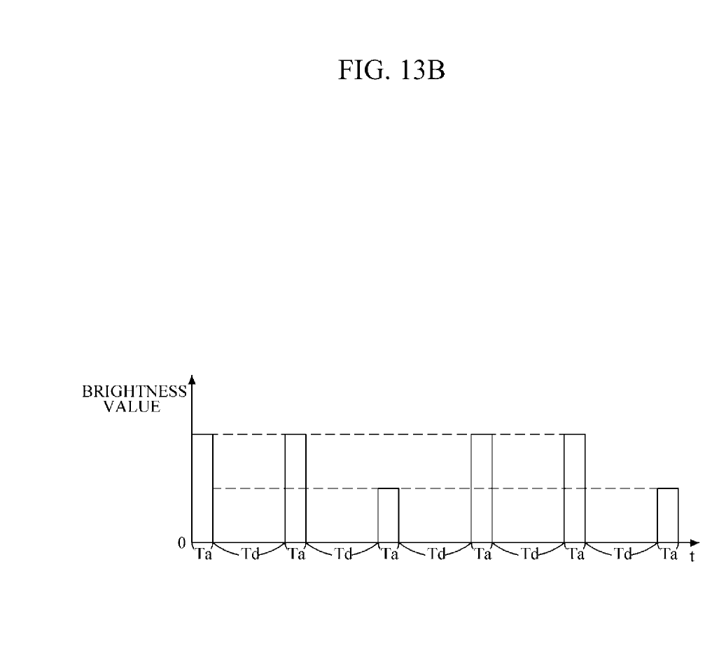

FIGS. 13A and 13B are diagrams illustrating a method for operating an operation recognition mode according to an exemplary embodiment of the present invention. In order to save battery consumption, a portion of pixel units may be activated and deactivated periodically. As shown in FIG. 13A, a relatively short activation period Ta and a relatively long deactivation period Td may be repeated. If the portion of pixel units senses an input object, the operation recognition mode may be initiated. For example, as shown in FIG. 13B, the shaking of the input object may be sensed if a first brightness value and a second brightness values are repeatedly detected during multiple activation periods. Further, if the moving direction is repeatedly changed, i.e., a repetition of plus (+) and minus (−) values representing different directions may be detected. If the shaking of the input object is detected, the operation recognition mode may be initiated. Thus, the operation recognition mode that may discharge the battery more rapidly may be operated if the shaking of the input object is detected. Further, the operation recognition mode may be terminated if a movement of the input object has not been detected for a determined time period. For example, if a timer is expired, the operation recognition mode may be terminated. If a movement of the input object is detected, the timer may be reset to zero. The method described with respect to FIG. 13A or FIG. 13 B may be applied to the proximity sensor such as IR LED if the proximity sensor is employed in the apparatus.

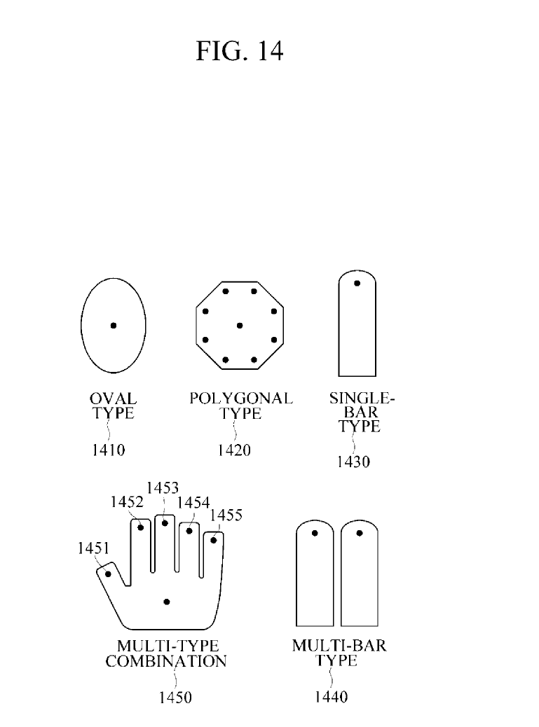

FIG. 14 is a diagram illustrating examples of analyzed types of input objects according to an exemplary embodiment of the present invention. If the frame analysis unit 134 recognizes boundary areas based on the movement of an input object, the frame analysis unit 134 may analyze and determine the type of the input object based on the determined boundary areas. The frame analysis unit 134 may determine a type of the input object among a plurality of types such as an oval type 1410, a polygonal type 1420, a single-bar type 1430, a multi-bar type 1440, and the like. Further, the frame analysis unit 134 may determine the type of the input object as a multi-type combination 1450 of the plurality of types. For example, a combination of the oval type 1410 and the multi-bar type 1440. If the type of the input object is determined, the frame analysis unit 134 may determine one or more feature points based on the determined type. Dots illustrated in FIG. 14 are examples of determined feature points. Feature points may be determined in a protruded portion where boundaries have a +higher curvature. For example, the oval type 1410 and the polygonal type 1420 may have a centroid as a feature point. The single-bar type 1430 and the multi-bar type 1440 may have a feature point on one end portion of a bar as shown in FIG. 14. The feature points may be ranked based on the movement degree of each feature point. For example, a hand image may be recognized as a multi-type combination. If the pointer finger (“index finger”) moves more actively than the other fingers, the feature point 1452 may be ranked higher than other feature points 1451, 1453, 1454, and 1455, for example. The user input recognition unit 135 may determine a user input based on the movement of the feature points and the ranks of the feature points. A higher-ranked feature point may have a higher weight for determining the user input. Thus, the movement of the pointer finger may be more relevant to determine a user input. Further, a movement of each feature point may be used to determine a plurality of sub-inputs. For example, five sub-inputs may be detected from movements of five fingers.

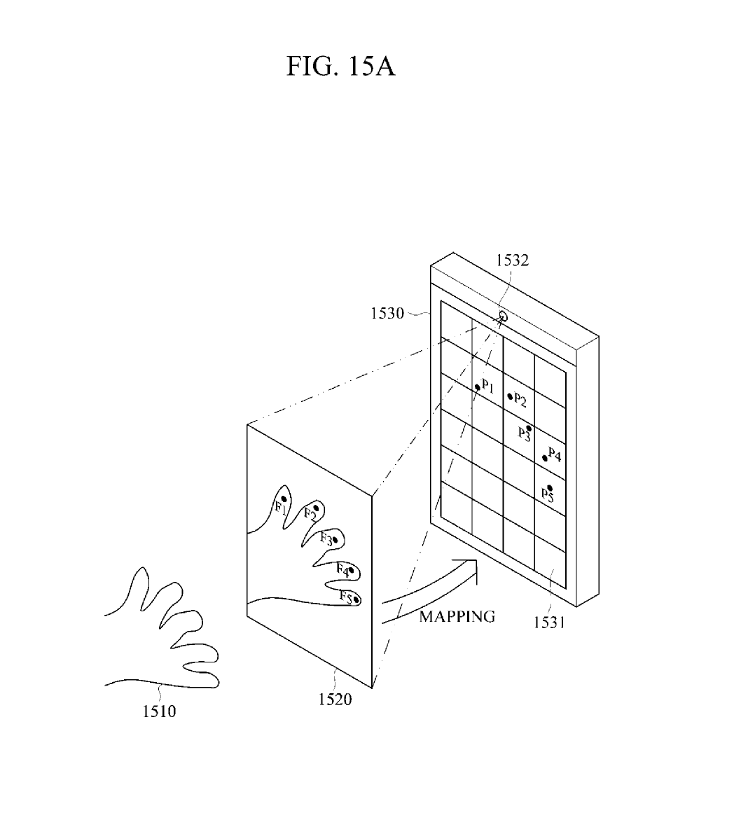

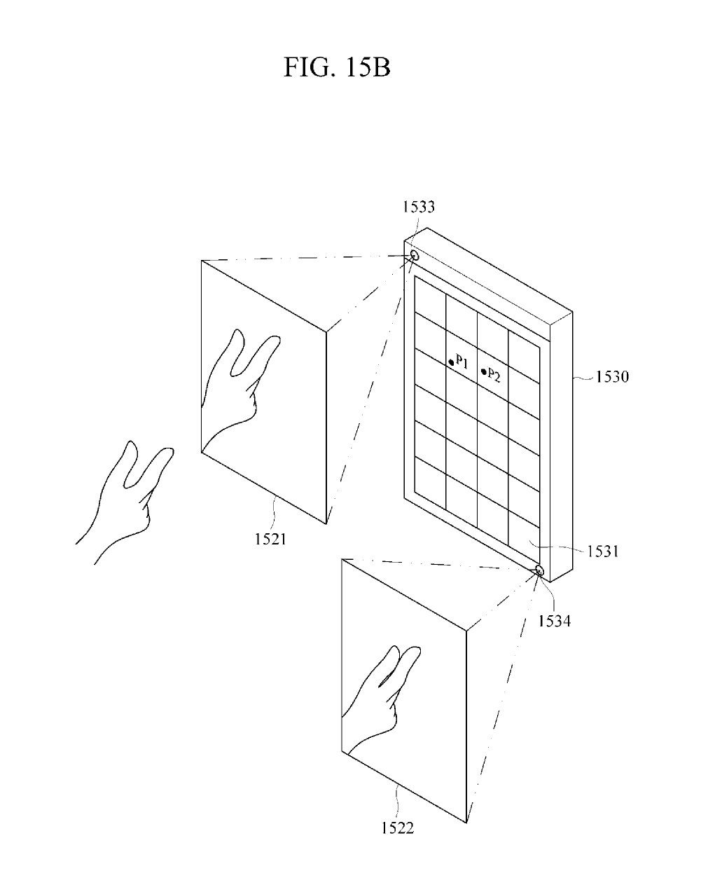

FIGS. 15A and 15B are diagrams illustrating a method for recognizing a user input using a mobile terminal having one or more cameras according to an exemplary embodiment of the present invention. Referring to FIG. 15A, an input object may be a user's hand 1510. The mobile terminal 1530 may operate a camera 1532 to receive incident light and a frame analysis unit (not shown) may recognize a movement of the user's hand 1510 based on information received from the camera 1532, and generate input recognition frames 1520 periodically. The frame analysis unit may obtain boundaries of the user's hand 1510 and obtain one or more feature points f1, f2, f3, f4, and f5. The movement of the feature points f1, f2, f3, f4, and f5 may be used to determine a user input. Further, one or more pointers p1, p2, p3, p4, and p5 may be displayed on a display screen 1531. Further, one pointer (not shown) representing the user input may be displayed on the display screen 1531 to provide feedback information of the user input. The pointers p1, p2, p3, p4, and p5 or the pointer representing the user input may be displayed as a form of a distinct dot, arrow, and the like, for example. Referring to FIG. 15B, multiple cameras 1533 and 1534 may be used to receive a user input. The cameras 1533 and 1534 may generate input recognition frames 1521 and 1522, respectively. The input recognition frame 1521 may include two feature points f1a and f2a, and the input recognition frame 1522 may include two feature points f1b and f2b. Two pointers p1 and p2 may be displayed on the display screen 1531. The pointer p1 may be determined based on the feature points f1a and f1b, and the pointer p2 may be determined based on the feature points f2a and f2b. Further, more than two cameras may be utilized.

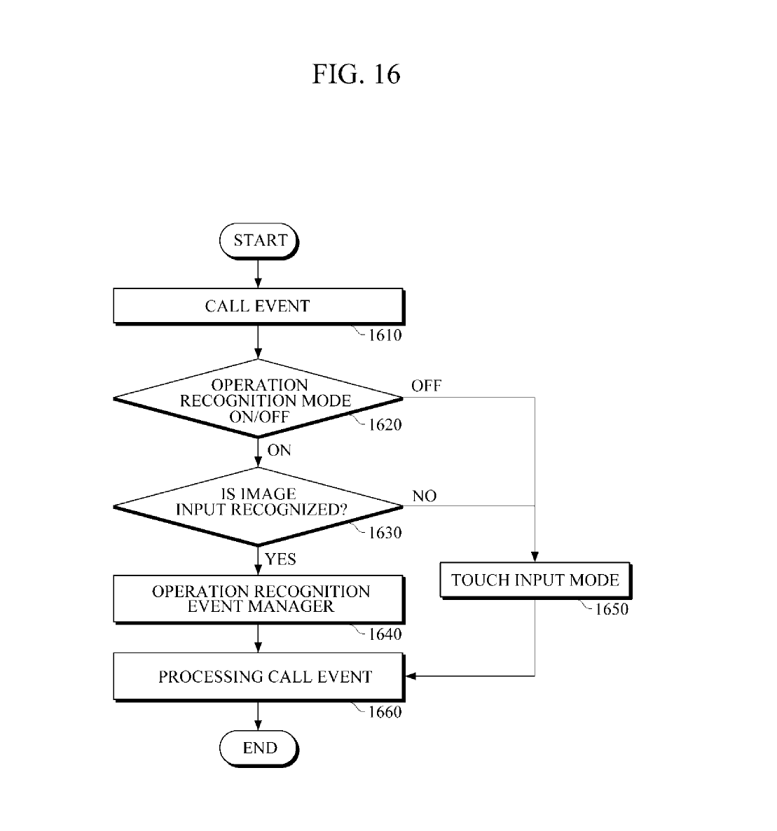

FIG. 16 is a diagram illustrating a method for recognizing a user input using a camera according to an exemplary embodiment of the present invention. Referring to FIG. 16, a call event may occur in operation 1610. A mobile terminal may receive a call from another user and output an audible sound, a vibration, a light, and the like. The mobile terminal may determine whether an operation recognition mode is enabled for the call event in operation 1620. If the operation recognition mode is enabled for the call event, the mobile terminal may determine whether an image input is recognized in operation 1630. If the image input is recognized, the mobile terminal may initiate an operation recognition event manager in operation 1640. The operation recognition event manager may be a software implementation of the operations performed by the camera mode control unit 133, the frame analysis unit 134, and the user input recognition unit 135 and be configured to manage an operation recognition mode using at least a processor, a memory, a camera. The mobile terminal may process the call event according to the recognized user input in operation 1660. If the operation recognition mode is disabled for the call event in operation 1620 or the image input is not recognized in operation 1630, the mobile terminal may receive a touch input in a touch input mode in operation 1650. If the mobile terminal receives a touch input, the mobile terminal may process the call event according to the received touch input in operation 1660.

The operation recognition event manager may manage an operation for recognizing an image, an operation for determining a user input based on the image, an operation for converting the user input to a control signal, and an operation for processing the control signal. For example, the conversion operation for a call event may be performed based on table 2.

TABLE 2

| CONVERSION | DETERMINATION | CONVERSION |
|---|---|---|
| TABLE | RESULT | RESULT |
| CALL EVENT | GESTURE_LEFT | NO CONVERSION |
| | GESTURE_RIGHT | NO CONVERSION |
| | GESTURE_WAVE | G_RECV_CALL |
| | GESTURE_COVER | G_SILENT_CALL |
| | GESTURE_PUSH | NO CONVERSION |
| | GESTURE_PULL | NO CONVERSION |
| | GESTURE_ZWAVE | G_DENY_CALL |

As shown in table 2, operation recognition event manager may determine a user input as GESTURE_LEFT (a movement of an input object in the left direction), GESTURE_RIGHT (a movement of the input object in the right direction), GESTURE_WAVE (a wave-shaped movement of the input object), GESTURE_COVER (a movement of the input object covering the camera), GESTURE_PUSH (a movement of the input object toward the camera), GESTURE_PULL (a movement of the input object away from the camera), OR GESTURE_ZWAVE (a Z-shaped movement of the input object). If the user input is determined as the GESTURE_WAVE, the operation recognition event manager may generate a control signal G_RECV_CALL to receive the call. If the user input is determined as the GESTURE_COVER, the operation recognition event manager may generate a control signal G_SILENT_CALL to convert an audible sound into a vibration. If the user input is determined as the GESTURE_ZWAVE, the operation recognition event manager may generate a control signal G_DENY_CALL to deny the call.

Further, a conversion operation for a photo galley may be performed based on table 3.

TABLE 3

| CON- | | |
|---|---|---|
| VERSION | DETERMINATION | |
| TABLE | RESULT | CONVERSION RESULT |
| PHOTO | GESTURE_LEFT_F | SLIDESHOW_LEFT_FAST |
| GALLERY | GESTURE_LEFT_M | SLIDESHOW_LEFT |
| | GESTURE_LEFT_S | SLIDESHOW_LEFT_SLOW |
| | GESTURE_RIGHT_F | SLIDESHOW_RIGHT_FAST |
| | GESTURE_RIGHT_M | SLIDESHOW_RIGHT |
| | GESTURE_RIGHT_S | SLIDESHOW_RIGHT_SLOW |
| | GESTURE_WAVE | RESORT_PIC |
| | GESTURE_COVER | STOP_ACTION |
| | GESTURE_PUSH | ZOOM_IN_PIC |
| | GESTURE_PULL | ZOOM_OUT_PIC |
| | GESTURE_ZWAVE | QUIT_GALLERY |
| | GESTURE_UP | SEND_CLOUD_PIC |
| | GESTURE_DOWN | DELETE_PIC |

As shown in table 3, operation recognition event manager may determine a user input as GESTURE_LEFT_F (a fast movement of an input object in the left direction), GESTURE_LEFT_M (a normal movement of an input object in the left direction), GESTURE_LEFT_S (a slow movement of an input object in the left direction), GESTURE_RIGHT_F (a fast movement of the input object in the right direction), GESTURE_RIGHT_M (a normal movement of the input object in the right direction), GESTURE_RIGHT_S (a slow movement of the input object in the right direction), GESTURE_WAVE (a wave-shaped movement of the input object), GESTURE_COVER (a movement of the input object covering the camera), GESTURE_PUSH (a movement of the input object toward the camera), GESTURE_PULL (a movement of the input object away from the camera), GESTURE_ZWAVE (a Z-shaped movement of the input object), GESTURE_UP (a movement of the input object in the upper direction), or GESTURE_DOWN (a movement of the input object in the down direction). If the user input is determined as the GESTURE_LEFT_F, the operation recognition event manager may generate a control signal SLIDESHOW_LEFT_FAST to scroll the gallery pictures to the left (or right) at a faster speed. If the user input is determined as the GESTURE_LEFT_M, the operation recognition event manager may generate a control signal SLIDESHOW_LEFT to scroll the gallery pictures to the left (or right) at a normal speed. If the user input is determined as the GESTURE_LEFT_S, the operation recognition event manager may generate a control signal SLIDESHOW_LEFT_SLOW to scroll the gallery pictures to the left (or right) at a slower speed. If the user input is determined as the GESTURE_RIGHT_F, the operation recognition event manager may generate a control signal SLIDESHOW_RIGHT_FAST to scroll the gallery pictures to the right (or left) at a faster speed. If the user input is determined as the GESTURE_RIGHT_M, the operation recognition event manager may generate a control signal SLIDESHOW_RIGHT to scroll the gallery pictures to the right (or left) at a normal speed. If the user input is determined as the GESTURE_RIGHT_S, the operation recognition event manager may generate a control signal SLIDESHOW_RIGHT_SLOW to scroll the gallery pictures to the right (or left) at a slower speed. If the user input is determined as the GESTURE_WAVE, the operation recognition event manager may generate a control signal RESORT-PIC to re-sort pictures. If the user input is determined as the GESTURE_COVER, the operation recognition event manager may generate a control signal STOP ACTION to stop or freeze an operation. If the user input is determined as the GESTURE_PUSH, the operation recognition event manager may generate a control signal ZOOM_IN_PIC to zoom-in pictures. If the user input is determined as the GESTURE_PULL, the operation recognition event manager may generate a control signal ZOOM_OUT_PIC to zoom-out pictures. If the user input is determined as the GESTURE_ZWAVE, the operation recognition event manager may generate a control signal QUIT_GALLERY to terminate the photo gallery application. If the user input is determined as the GESTURE_UP, the operation recognition event manager may generate a control signal SEND_CLOUD_PIC to send pictures to a cloud server. If the user input is determined as the GESTURE_DOWN, the operation recognition event manager may generate a control signal DELETE_PIC to delete selected pictures.

According to exemplary embodiment of the present invention, a user input may be recognized using an image sensor even in an environment in which a touch input is not available. Thus, it may be possible to provide an image sensing input interface for sensing and analyzing images including an input object. Further, the recognition of the user input using the image sensing input interface may be robust in an environment in which the temperature may change. Further, a supportive user interface that is operable without a touch input may be provided to the user.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus, comprising:
an image sensor to obtain optical image information;
a control unit to generate input recognition information based on the optical image information, and to determine a user input based on the input recognition information; and
a display unit to display control information corresponding to the user input.

2. The apparatus of claim 1, wherein the input recognition information comprises an input recognition frame having a region corresponding to an input object.

3. The apparatus of claim 1, wherein the control information comprises a display image determined according to the user input.

4. The apparatus of claim 2, wherein the control information comprises a pointer corresponding to a feature point associated with the input recognition information.

5. The apparatus of claim 2, wherein the user input is determined based on a change of the region represented by multiple input recognition frames.

6. The apparatus of claim 5, wherein the region is determined based on a brightness value included in the optical image information.

7. The apparatus of claim 5, wherein the control unit obtains a feature point based on information of the region, and calculates a coordinate value for the feature point.

8. The apparatus of claim 7, wherein the control unit determines moving velocity information of the feature point based on the multiple input recognition frames.

9. The apparatus of claim 1, wherein the control unit generates input recognition information while in an input recognition mode, and
the image sensor converts the optical image information to image data, and the display unit displays an image corresponding to the image data while in a photographing mode.

10. The apparatus of claim 2, wherein an aspect ratio of the input recognition frame corresponds to an aspect ratio of a display screen or the image sensor.

11. The apparatus of claim 1, wherein the control unit controls the image sensor to operate in an input recognition mode in response to an event or a setting input.

12. The apparatus of claim 11, wherein the display unit displays a setting screen comprising candidate events, the setting screen to receive the setting input to set the event from among the candidate events.

13. A method for recognizing a user input, comprising:
obtaining optical image information;
generating input recognition information based on the optical image information, the input recognition information comprising a region corresponding to an input object; and
determining a user input based on the input recognition information.

14. The method of claim 13, further comprising:
determining boundaries of the region according to values included in the optical image information; and
calculating a coordinate value for a feature point based on the determined boundaries.

15. The method of claim 13, further comprising:
displaying control information corresponding to the user input.

16. The method of claim 15, wherein the control information comprises a display image determined according to the user input.

17. The method of claim 13, wherein the user input is determined based on a change of the region represented by multiple input recognition frames.

18. The method of claim 13, wherein the region is determined based on a brightness value included in the optical image information.

19. The method of claim 14, wherein the control unit determines moving velocity information of the feature point based on multiple input recognition frames.

20. The method of claim 13, further comprising:
detecting an event or a selection input to initiate an input recognition mode; and
recognizing a command input as the user input using an image sensor in the input recognition mode.

21. A method for recognizing an input, comprising:
receiving optical information comprising information of an input object;
generating an input recognition frame based on the optical information, the input recognition frame comprising a region corresponding to the input object and boundaries of the region being determined based on the optical information; and
determining the input according to a location change of the region based on multiple input recognition frames.
